(19) United States
(12) Patent Application Publication
(10) Pub. No.: US 2014/0200959 A1
(43) Pub. Date: Jul. 17, 2014

(54) PREDICTING FUTURE PERFORMANCE OF GAMES

(71) Applicant: BIG FISH GAMES, INC., Seattle, WA (US)

(72) Inventors: Benjamin Aaron Sarb, Seattle, WA (US); Shan Heng, Issaquah, WA (US); Kelly Lee Baumeister, Seattle, WA (US); Liwei MA, Issaquah, WA (US)

(73) Assignee: BIG FISH GAMES, INC., Seattle, WA (US)

(21) Appl. No.: 13/743,042

(22) Filed: Jan. 16, 2013

(51) Int. Cl. G06Q 30/02

(52) U.S. Cl. CPC G06Q 30/0202
USPC 705/7.31; 705/7.32

(57) ABSTRACT

One or more games may be developed and then provided to a group of consumers prior to those games becoming publicly available. After the users play the games for a predetermined amount of time, user feedback may be solicited and received. A game score for each game may be generated based on the user feedback and the game score may be utilized to determine whether the games should be modified prior to being publicly released to consumers. Based at least in part on historical data for other games, such as game scores and past sales performance for games that were previously released, the sales performance for the games that have yet to be released may be predicted. Such predictions may be generated based at least in part on one or more predictive models and/or regression analysis.

### BACKGROUND

With the growing popularity of casual gaming, consumers are able to play various types of games utilizing different mediums, including computing devices, tablet devices, mobile telephones, etc. Prior to making the games available to the public, however, entities that create and/or distribute the games often spend a great deal of time developing different versions of the games in order to create the best game possible. More particularly, these entities may create the games based on preferences of consumers (e.g., likes, dislikes, genres, etc.). That is, the creator of the games may want to develop games that are most enjoyable for the consumers to play, which may also increase the amount of sales associated with those games. However, since the success of games (e.g., amount of sales, sales revenue, enjoyment of consumers, etc.) is often not known until the games are actually distributed to and played by consumers, it may be difficult to determine whether certain games will be successful prior to those games being released.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including a user, a user device, a developer, one or more networks, and one or more content servers. In this system, the amount of sales associated with one or more games may be predicted based at least in part on feedback from the user.

FIG. 2 is a diagram showing an example process of predicting the amount of sales associated with one or more games based at least in part on surveys received from users, historical sales data, and/or one or more predictive models.

FIG. 3 is a diagram showing an example process of developing one or more games based at least in part on surveys received from users, historical sales data, and one or more predictive models.

FIG. 4 is a flow diagram showing an example process of predicting the sales performance of a game based at least in part on user feedback.

### DETAILED DESCRIPTION

This disclosure describes systems and/or processes for generating predictive information that may indicate the future success of one or more games. More particularly, the systems and/or processes described herein may predict the amount of sales and/or sales revenue associated with one or more games based at least in part on feedback received from consumers (e.g., via surveys, questionnaires, etc.), historical sales data for other games, and/or one or more predictive models. Moreover, the success of a particular game (e.g., amount of sales, user enjoyability, etc.) may be predicted before that game is actually available to consumers. This predictive data may then be used to determine whether games should be released or whether the games should be modified or further developed prior to being released. For the purposes of this discussion, the games described above and set forth in additional detail below may include games that are played online, such as games played via a network (e.g., the Internet).

In various embodiments, prior to a game being released to consumers, the game may be provided to a subset or a group of consumers. In exchange for allowing those consumers to play the game for a limited period of time, the consumers may complete a survey relating to the game, which may include both general and specific questions relating to the overall quality of the game and/or features or aspects associated with the game. Upon receiving the completed surveys, a game score may be generated for that particular game. Based at least in part on the game score, the game may be released to the public, modified and/or re-developed, or not released to the public. In some embodiments, provided that the game is modified and/or re-developed, the systems and/or processes described herein may repeat the survey process and then calculate a second game score for this game. At this point, a determination may then be made regarding whether the game should be released or redeveloped.

For games that have been made available to consumers, the systems and/or processes described herein may monitor, record, and/or maintain sales data associated with those games. In particular, the number of units of games sold and/or the sales revenue associated with those games may be stored, and may also be referred to as historical sales data. Additionally, for the games that went through the survey process and therefore were played (e.g., tested) by consumers prior to being released, the game scores that were generated for those games may be associated with the sales data. As a result, the systems and/or processes described herein may determine correlations or associations between the game score for a particular game and its corresponding sales data (e.g., amount of units sold, sales revenue, etc.).

In additional embodiments, once a game score for a particular game has been calculated, the systems and/or processes described herein may determine predictive data associated with this game. More particularly, since historical sales data may be maintained for games that were previously released, the game score(s) that were generated for these games prior to these games being released may be representative of the success of those games. Accordingly, based at least in part on previously released games (e.g., previous game score(s), sales data, etc.), the game score(s) for games that have yet to be released may be utilized to predict the future sales (e.g., amount of units sold, revenue, etc.) for the yet to be released games. In some embodiments, regression analysis (e.g., a linear regression) and/or one or more predictive models may be utilized to determine the predictive data for a particular game. As a result, the systems and/or processes described herein may utilize user-submitted feedback, historical sales data, and/or a predictive model may be used to determine whether games will be successful and/or enjoyed by consumers.

The discussion begins with a section, entitled “Example Environment,” describing an architecture for predicting sales data associated with one or more games. Next, the discussion includes a section, entitled “Prediction of Sales Performance,” that describes a system for predicting the sales performance of one or more games. A “User Feedback for Games” section then follows, which describes soliciting and receiving user feedback relating to one or more games. The discussion then includes a section, entitled “Example Processes,” that illustrates and describes example processes for implementing the described techniques. Lastly, the discussion includes a brief “Conclusion.”

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

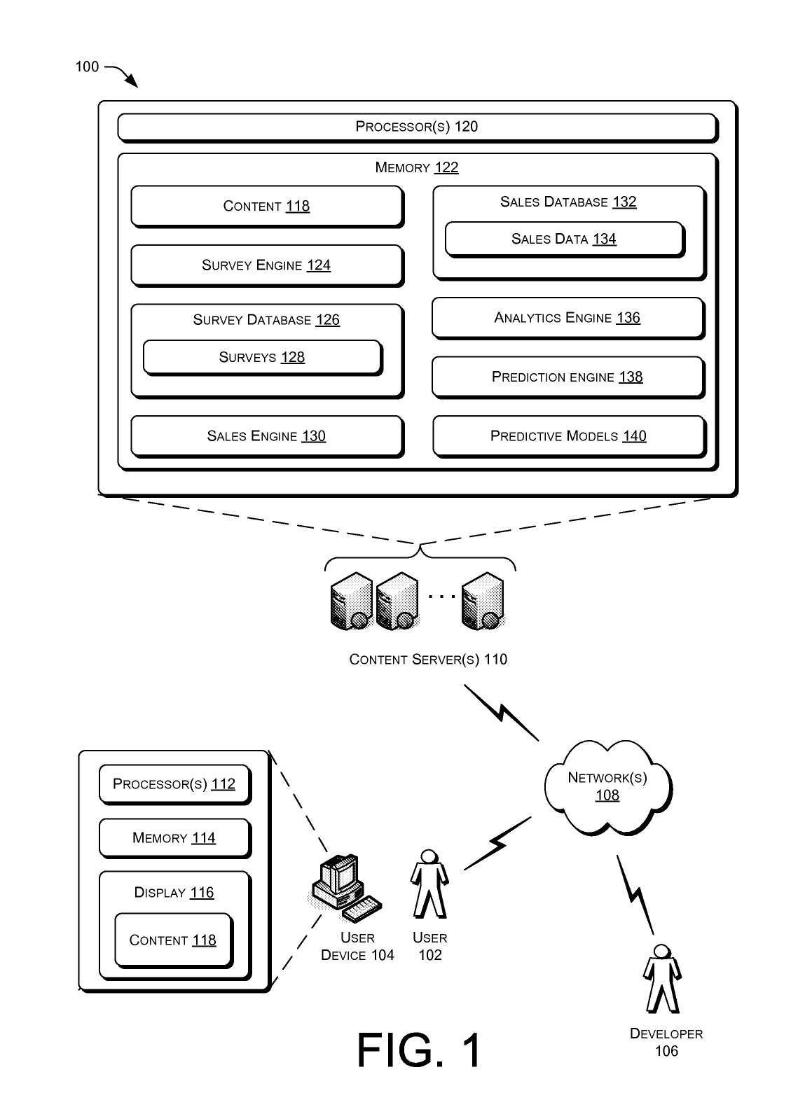

FIG. 1 illustrates an architecture 100 in which a user 102 may electronically access content 118, such as software games, and play that content 118 on a user device 104. As described below, the user device 104 may be implemented in any number of ways, such as a computer, a laptop computer, a tablet device, a personal digital assistant (PDA), a multi-functioning communication device, and so on. The user 102 may access the content 118 over one or more network(s) 108, such as the Internet, which may be communicatively coupled to one or more content server(s) 110. In addition, a developer 106, such as a third-party developer 106 and/or a developer 106 that is otherwise associated with the content server(s) 110, may create and/or develop the content 118. The content server(s) 110 may store various types of content 118, such as software games, media content (e.g., audio content, video content, etc.), and other types of content that are accessible by the user device 104. For instance, the user 102 may access and/or play the content 118 via one or more sites (e.g., a website) that are accessible via the network(s) 108. One or more processor(s) 112, a memory 114, and a display 116 of the user device 104 may enable the user 102 to access and/or play the content 118 (e.g., games). In addition to the content 118 being stored on, and/or accessed via, the content server(s) 110, the content 118 may also be stored directly on the user device 104.

In some embodiments, the user 102 may be given the opportunity to access and/or play the content 118 prior to the content 118 being released to consumers. More particularly, the user 102 may be part of a subset or group of consumers that are able to play the content 118 (e.g., a game) before the general public is able to acquire the content 118. In exchange for this access, the user 102 may have to complete a survey 128 that may include questions that relate to whether the user 102 liked or disliked the content 118. For instance, the survey 128 may include questions that relate to the overall quality of the content 118, whether the user 102 would be interested in acquiring the content 118, whether the user 102 enjoyed playing the content 118, and so on. Once the survey 128 is completed, the user 102 may return the completed survey 128 to the content server(s) 110, an entity associated with the content 118, and/or an entity/individual that created, developed, and/or distributed the content 118.

Furthermore, one or more processor(s) 120 and a memory 122 of the content server(s) 110 may allow the content server(s) 110 to provide the content 118 and/or surveys 128 associated with that content 118 to users 102, generate scores for the content 118 based at least in part on the completed surveys 128, track sales data 134 associated with the content 118 that has been released to consumers, and determine predictive data about content 118 that is not yet publicly available based at least in part on the scores and the historical sales data 134. More particularly, a survey engine 124, a survey database 126, a sales engine 130, a sales database 132, an analytics engine 136, a prediction engine 138, and one or more predictive models 140 may be stored in memory 120 and executed by the processor(s) 120 to enable the content server(s) 110 to perform the actions set forth above. For the purposes of this discussion, the content 118 may be any type of content that may be rendered, distributed to, acquired, and/or consumed by the user 102, such as games, video content, audio content, etc. Moreover, in certain embodiments, the games may relate to casual gaming, which may include online games that may be played over the network(s) 108, and/or software games that may be downloaded to, stored on, and/or be accessible by, the user device 104. For instance, the content 118 (e.g., games) may be downloaded from a site (e.g., website) associated with the content server(s) 110 to a user device 104 associated with a user 102.

In various embodiments, casual games may include games (e.g., video games) that are associated with any type of gameplay and any type of genre. Casual games may have a set of simple rules that allow a large audience to play, such as games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices, etc., and may be played online via a web browser. Casual games may be referred to as “casual” since the games may be directed towards consumers who can come across the game and get into gameplay in a short amount of time, if not immediately. Examples of casual games may include puzzle games, hidden object games, time management games, adventure games, strategy games, arcade and action games, word and trivia games, and/or card and board games.

In various embodiments, the user 102 may access and/or play the content 118 utilizing the corresponding user device 104 and/or an application associated with the user device 104. This content 118, which may include games and casual games as described above, may also be acquired (e.g., purchased, rented, leased, etc.) by the user 102 and/or tested by the user 102 before the content 118 becomes publicly available and/or is released to other consumers. Regardless of whether the content 118 is stored on the user device 104 or the content server(s) 110, playing the content 118 may include accessing, viewing, trying, testing, and/or otherwise interacting with the content 118. However, for the purpose of this discussion, the terms content 118 and games, including casual games, may be used interchangeably.

The user 102 may access the content 118 in any of a number of different manners. For instance, the user 102 may access a site (e.g., a website) associated with an entity, such as a merchant, that provides access to the content 118. Such a site may be remote from the user device 104, but may allow the user 102 to interact with the content 118 via the network(s) 108. Moreover, the user 102 may download one or more applications to the user device 104 in order to access the content 118. In this case, the content server(s) 110 may provide and/or distribute the content 118 to the user device 104, whereby the user 102 may interact with the content 118 via the downloaded application(s). In other embodiments, the content 118 may be streamed from the content server(s) 110 to the user device 104 such that the user 102 may interact with the content 118 in real-time. Once the user 102 accesses the content 118, the user 102 may perform a variety of actions, including learning about the content 118, viewing the content 118, trying the content 118, acquiring (e.g., purchasing, renting, leasing, etc.) the content 118, downloading and/or installing the content 118 to the user device 104, and/or completing one or more surveys 128 relating to the content 118.

Additionally, the user 102 may have a user account associated with the entity that provides and/or provides access to the content 118. For instance, assuming that the content 118 is available via a website, the user 102 may have a user account that specifies various types of information relating to the user 102. This information may include personal information, user preferences, and/or some user identifier (ID), which may be some combination of characters (e.g., name, number, etc.) that uniquely identifies the user 102 from other users 102. In various embodiments, the identifier may be referred to as a master ID and may be different from each master ID that corresponds to other users 102. The master ID for each user 102 may be used by the content server(s) 110 to select users 102 that are to access and/or play the content 118 prior to the content becoming publicly available. The master IDs for the users 102 may also be used to track sales of the content 118, which may be stored as the sales data 134. In some embodiments, multiple related users 102 may be associated with the same master ID and/or a single user 102 may have multiple master IDs. In other embodiments, the master IDs may be associated with one or more e-mail addresses or other identifying characteristics associated with the user 102.

In some embodiments, the user device 104 may be any type of device that is capable of receiving, accessing, and/or interacting with the content 118 (e.g., games) and/or that is capable of receiving and completing surveys 128 associated with the content 118, such as, for example, a personal computer, a laptop computer, a cellular telephone, a personal digital assistant (PDA), a tablet device, an electronic book (e-Book) reader device, a television, or any other device that may be used to access content 118 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the content 118. In other embodiments, the user 102 may user the user device 104 to receive one or more surveys 128 relating to the content 118, complete the surveys 128, and then return the surveys 128 to the content server(s) 110, or some other entity or individual associated with the content 118. Further, the user device 104 shown in FIG. 1 is only one example of a user device 104 and is not intended to suggest any limitation as to the scope of use or functionality of any user device 104 utilized to perform the processes and/or procedures described herein.

The processor(s) 112 of the user device 104 may execute one or more modules and/or processes to cause the user device 104 to perform a variety of functions, as set forth above and explained in further detail in the following disclosure. In some embodiments, the processor(s) 112 may include a central processing unit (CPU), a graphics processing unit (GPU), both CPU and GPU, or other processing units or components known in the art. For instance, the processor(s) 112 may allow the user device 104 to access sites associated with content 118, download applications that are used to access and/or play the content 118, and/or interact with surveys 128 that relate to the content 118. Additionally, each of the processor(s) 112 may possess its own local memory, which also may store program modules, program data, and/or one or more operating systems.

In at least one configuration, the memory 114 of the user device 104 may include any component that may be used to access, play, and/or download the content 118, and/or may be used to receive, complete, and transmit surveys 128 associated with the content 118. Depending on the exact configuration and type of the user device 104, the memory 114 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 116 and other output device(s), such as speakers, a printer, etc. The user 102 may utilize the foregoing features to interact with the user device 104 and/or the content server(s) 110 via the network(s) 108. More particularly, the display 116 of the user device 104 may include any type of display known in the art that is configured to present (e.g., display) information to the user 102. For instance, the display 116 may be a screen or user interface that allows the user 102 to access, play, and/or download the content 118 and that allows the user 102 to complete surveys 128 associated with the content 118. Further, one or more local program modules may be utilized to play the content 118 and/or present the surveys 128 via a browser. The local program modules may be stored in the memory 114 and/or executed on the processor(s) 112 in order to present graphics associated with the content 118 on the display 116.

In various embodiments, the developer 106 may be any entity and/or individual that is involved with creating and/or developing the content 118. For instance, in the context of games, the developer 106 may create a concept for a game and actually develop the game that will be eventually be released to and played by consumers. The developer 106 may be an individual and/or entity that owns the rights to the content 118 and/or distributes the content 118, or may be otherwise associated with such an entity, such as being an employee of that entity. Alternatively, the developer 106 may be a third-party developer 106 that creates and/or develops the content 118 on behalf of an entity that owns the rights to the content 118 and/or distributes the content 118. Based at least in part on the feedback (e.g., surveys 128) received from the users 102, the developer 106 may also modify and/or redevelop the content 118.

In some embodiments, the network(s) 108 may be any type of network known in the art, such as the Internet. Moreover, the user device 104, the developer 106, and/or the content server(s) 110 may communicatively couple to the network(s) 108 in any manner, such as by a wired or wireless connection. The network(s) 108 may also facilitate communication between the user device 104, the developer 106, and/or the content server(s) 110, and also may allow for the transfer of data or communications therebetween. For instance, the content server(s) 110 and/or other entities may provide access to the content 116 that may be played and/or downloaded utilizing the user device 104. In addition, the network(s) 108 may allow one or more surveys 128 to be exchanged between the content server(s) 110 and the user 102.

In addition, and as mentioned previously, the content server(s) 110 may include one or more processor(s) 120 and a memory 122, which may include the content 118, the survey engine 124, the survey database 126, the sales engine 130, the sales database 132, the analytics engine 136, the prediction engine 138, and/or the one or more predictive models 140. Further, the survey database 126 may store one or more surveys 128 and the sales database 132 may store sales data 134. The content server(s) 110 may also include additional components not listed above that perform any function associated with the content server(s) 110. In various embodiments, the content server(s) 110 may be any type of server, such as a network-accessible server, or the content server(s) 108 may be associated with any entity that provides access to the content 118 and/or the surveys 128 that are stored on and/or are accessible by the content server(s) 110.

As mentioned previously, the content server(s) 110 may provide access to and/or distribute the content 118 to one or more users 102. Prior to the content 118 becoming available to consumers, the survey engine 124 of the content server(s) 110 may select a group or a subset of consumers that may be allowed to play the content 118 for a limited period of time. With the content 118, the survey engine 124 may also provide one or more surveys 128 to the subset of consumers (e.g., user 102). After the user 102 is finished playing the content 118, the user 102 may be prompted to complete the survey 128 that is associated with that particular content 118. In various embodiments, the survey 128 may include questions that relate to the user's 102 experience and/or opinions relating to the content 118. Once the survey 128 is completed, the user 102 may provide the survey 128 to the content server(s) 110 and/or to an entity or individual associated with the content 118. Accordingly, since the content 118 has not been publicly released, the content 118 may be modified and/or redeveloped based at least in part on the comments included in the completed surveys 128. That way, the content 118 may be modified in accordance with feedback specifically relating to that content 118. For instance, if the surveys 128 suggested that a particular aspect of the content 118 did not meet the user's 102 expectations, that aspect of the content 118 may be modified and/or improved.

In other embodiments, the survey database 126 may store the surveys 128 that are to be provided to the users 102 who are authorized to test the content 118 prior to release. Additionally, the survey database 126 may store the surveys 128 that have been provided to and also have been completed by the users 102. The survey database 126 may also be searchable so that surveys 128 associated with different content 118 may be queried and located. As a result, each survey 128 relating to a particular content 118 may be identified, retrieved, and utilized for further analysis.

Moreover, the sales engine 130 of the content server(s) 110 may enable users 102 to acquire (e.g., access, purchase, rent, lease, etc.) the content 118. For example, once the content 118 is available to consumers, consumers may acquire the content 118 and then download the content 118 to corresponding user devices 104 and/or play the content 118 via the content server(s) 110. The sales engine 130 may also monitor and record the extent to which each content item is acquired. For instance, for each content item (e.g., a game), the sales engine 130 may keep track of the sales data 134, which may include the number of units sold, the revenue received, and/or any other data relating to user 102 acquisition of the content 118. Accordingly, the content server(s) 110 may be able to track and maintain historical sales data 134 for each content item that is available to consumers. Upon obtaining this information, the sales data 134 may be stored in the sales database 132, which also may be searchable.

Based at least in part on the surveys 128 collected by the survey engine 124 and stored in the survey database 126 and/or the sales data 134 collected by the sales engine 130 and stored in the sales database 132, the analytics engine 136 may generate (e.g., calculate, compute, etc.) a score for one or more content items (e.g., games) included in the content 118. In some embodiments, provided that the surveys 128 allowed the users 102 to provide numerical ratings or scores in response to each question included in the surveys 128, the score may be computed by aggregating the scores and/or ratings submitted by the users 102. The scores may also be based at least in part on historical data, such as scores assigned to previously released content 118 and sales data 134 associated with that content 118. Therefore, for each content item (e.g., game), the game score may reflect the degree to which the users 102 liked and/or enjoyed that particular content item. In response, various aspects of the content 118 may be changed to address issues (e.g., overall quality, graphics, sound, etc.) that were identified during the survey process.

In addition, the analytics engine 136 may determine correlations or associations between the score of certain content 118 and the corresponding sales of that content 118 (e.g., amount of items sold, sales revenue, etc.). For example, the analytics engine 136 may determine that a content item that was determined to have a relatively high score had a significant amount of sales whereas a content item that had a lower score had a lower amount of sales. Therefore, the analytics engine 136 may determine whether there are correlations or associations between the score that is generated for and assigned to a content item prior to that content item being released and the amount of sales associated with that content item.

In various embodiments, the prediction engine 138 may predict the future sales performance (e.g., amount of sales, revenue, etc.) of a particular content item based at least in part on the score that is generated for that content item. For instance, using historical sales data relating to content 118 that has previously been released to consumers, and the scores that were previously assigned to that particular content 118, one or more correlations or associations may have been established. The prediction engine 138 may utilize these correlations or associations to determine the sales performance for content items that have yet to be released and/or have yet to become publicly available. In some embodiments, the one or more predictive models 140 may be able to consider the score that has been associated with a particular content item in order to predict future sales. Further, with respect to a particular content item, the predictive models 140 may utilize regression analysis in order to predict the amount of units that are expected to be sold for that content item.

### Prediction of Sales Performance

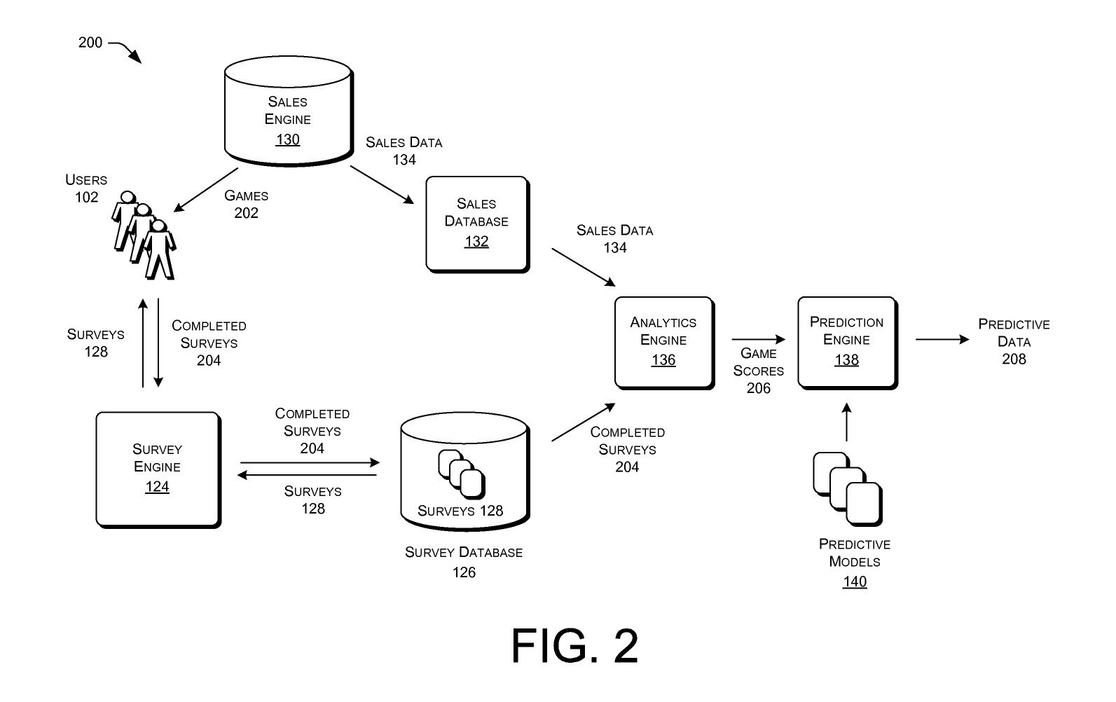

FIG. 2 illustrates a system 200 for predicting future sales performance of one or more games based at least in part on consumer feedback, historical sales data for other games, and/or one or more predictive models. As stated above with respect to FIG. 1, users 102 may access and/or play one or more games 202 via user devices 104 associated with those users 202. Moreover, and as stated above, one or more developers 106 may create and/or develop the games 202. However, before making the games 202 available to consumers, the individual and/or entity that owns the rights to the games 202 may want to test the games 202 to help ensure that the best possible versions of the games 202 are released and/or to help ensure that the games 202 will be of interest to consumers. In some embodiments, the games 202 that are played or tested by consumers prior to being released may be referred to as beta versions of the games 202. By receiving feedback from the users 102, certain aspects of the game may be adjusted, modified, and/or improved based at least in part on user preferences prior to actually releasing the games 202 to consumers.

In order to receive feedback relating to the games 202 prior to the games 202 actually being released to consumers, the survey engine 124 may select a group of consumers (e.g., users 102) that are willing and able to play the games 202 for a predetermined amount of time and provide personal feedback based on their respective playing experiences. In various embodiments, the users 102 that are selected to test the games 202 may be existing customers, potential customers, and/or may be selected as a benefit of having a membership with an entity associated with the games 202 (e.g., the content server(s) 110 and/or the rights owner, creator, developer, distributor, etc., of the games 202). Moreover, the entity associated with the games 202 may solicit feedback from a minimum number of users 102 in order to reduce the margin of error associated with the user feedback. Any number of the one or more games 202 may be eligible to be played prior to release and any mechanism may be used to select the games 202 that will be beta tested.

In various embodiments, the entity associated with the games 202 may receive and/or collect feedback from the users 102 using multiple different methods. For instance, the survey engine 124 may provide surveys 128 or questionnaires to the users 102 or may poll the users 102. Although any method may be used to collect feedback from the users 102, surveys 128 are illustrated in the context of FIG. 2. Additionally, the surveys 128 may be provided to the users 102 and the feedback may be received from the users 102 utilizing any manner of communication, such as, for example, e-mail, text messaging, instant messaging, telephone calls, and/or via a website. For instance, the users 102 may receive an e-mail that includes a link to download and/or play a particular game 202. Once the users 102 have played the game 202 for the allotted amount of time, the users 102 may be prompted to complete a survey 128 relating to the game 202. When the users 102 are finished with the surveys 128, the completed surveys 204 may be transmitted back to the survey engine 124. In some embodiments, the surveys 128 may be retrieved from the survey database 126 and the completed surveys 204 may be stored in the survey database 126.

In some embodiments, the surveys 128 may take any form and may include any questions relating to the games 202. For example, the questions included in the surveys 128 may request that the users 102 provide ratings, written responses, multiple choice, etc., and may also include follow-up questions based on the responses provided by the users 102. Moreover, the questions may relate to any aspect and/or feature of the games 202. Example questions may relate to an overall quality of the games 202, the likelihood that users 102 will acquire the games 202, the enjoyability of the games 202, audio and/or graphics of the game 202, the pace of the games 202, relative difficulty of the games 202, and/or any other aspect of the games 202 that are determined to be important to consumers.

In addition, the surveys 128 may be standardized, meaning that the same surveys 128 are sent to the users 102 even if those users 102 are playing different games 202. For the purposes of this discussion, the surveys 128 being standardized may mean that each survey 128 includes the same questions, regardless of which game 202 a particular survey 128 is associated with. Since the surveys 128 may be standardized, user feedback associated with a first game 202 may be compared to user feedback associated with a second, different game 202. In other embodiments, the each survey 128 that is provided to users 102 may be specifically associated with a particular one of the games 202.

In some embodiments, the sales engine 130 may enable the users 102 to acquire (e.g., purchase, lease, rent, borrow, etc.) the games 202 once the games 202 become publicly available. In addition, for each of the games 202 that are acquired by the users 102, the sales engine 130 may monitor, record, and maintain data associated with the sale of those games 202 (e.g., sales data 134). For example, with respect to a particular game 202, the sales engine 130 may track the amount of units that are sold and/or the revenue received from such sales. Moreover, the sales engine 130 may store the sales data 134 in the sales database 132. As a result, the sales database 132 may maintain historical sales data 134 for each game 202 that is tested and/or is acquired by the users 102. In further embodiments, the sales data 134 and/or the completed surveys 204 may be utilized by the analytics engine 136 for further analysis.

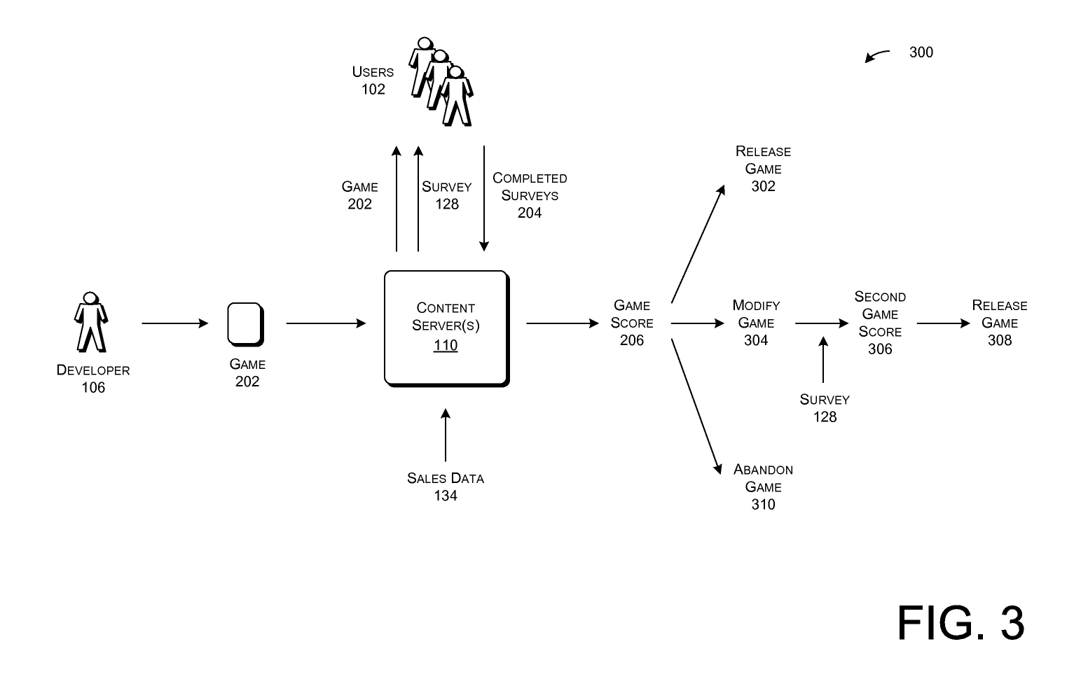

As described in additional detail with respect to FIG. 3, once a particular game 202 is developed into a beta version, and both the game 202 and the corresponding survey 128 are provided to the users 102, the analytics engine 136 may generate a game score 206 for that game 202 based at least in part on the completed surveys 204 and/or the sales data 134. In various embodiments, the game score 206 may represent an overall quality of the game 202 and/or a collective response to the game 202 by the users 102 that tested the game 202. After the game score 206 is generated, the game 202 may be publicly released to consumers without any modifications. Alternatively, if the game score 206 does not meet a certain threshold, the game 202 may be modified based at least in part on the user feedback. The survey process may then be repeated for that particular game 202 and a second game score 206 may be calculated based at least in part on the additional feedback received from the users 102. At this point, if the second game score 206 is sufficiently high (e.g., meets the predetermined threshold), the game 202 may be released to consumers. If not, the game 202 may go through additional iterations of the survey process until it is determined whether the game 202 will be released or not.

In various embodiments, for each game 202, the generated game score 206 that precedes the actual release of the game 202 may be referred to as the pre-release game score 206. Therefore, the pre-release game score 206 may represent the game score 206 that represents the final version of the game 202 that is released to consumers. Depending upon the number of survey iterations the game 202 goes through, the pre-release game score 206 may be the first game score 206, the second game score 206, and so on. As described in additional detail below, the pre-release game score 206 for a particular game 202 may be compared to the sales performance of that game 202 in order to determine correlations or associations between these two variables. In contrast, the game scores 206 that precede the pre-release game score 206 may be used to modify the games 202 based at least in part on user preferences (e.g., user feedback).

The analytics engine 136 may calculate the game scores 206 in any manner. In one embodiment, after a predetermined amount of time (e.g., a week), the completed surveys 204 for a particular game 202 may be aggregated and the analytics engine 136 may determine the game score 206 for that game 202. The data included in the completed surveys 204 and/or the game score 206 itself may be incorporated into a report that may be provided to any individual and/or entity that is associated with the creation, development, distribution, and/or ownership of the game 202. As stated above, based on this information, the game 202 may be released or modified prior to being released.

Therefore, the analytics engine 136 may generate a metric (e.g., the game score 206) for each game 202 that may be compared against other games 202. In addition, the game scores 206 that are determined prior to release of the games 202 may subsequently be compared to the sales performance of those games 202. As a result, correlations or associations between the game scores 206 and the relative success of those games 202 may be determined. Further, for a game 202 that has been assigned a game score 206 but has yet to be released, these correlations or associations may be utilized to predict a future sales performance (e.g., amount of units sold, revenue, etc.) for that particular game 202.

As shown, the game scores 206 generated by the analytics engine 136 may be accessed by the prediction engine 138. Moreover, since the sales data 134 is maintained for each of the games 202, correlations or associations may be established between the game score 206 for each game 202 and the sales performance (e.g., number of units sold, revenue, etc.) for that game 202. As a result, given a game score 206 for a game 202 that has yet to be released (e.g., pre-release game score 206), the prediction engine 138 may utilize the correlations or associations to generate predictive data 208, which may include a prediction of the sales performance of that game 202. That is, by considering pre-release game scores 206 and the corresponding sales performance of other games 202, the prediction engine 138 may predict the amount of sales (e.g., number of units sold, sales revenue, etc.) of a new game 202 based on the pre-release game score 206 that has been generated for that new game 202.

In some embodiments, user feedback (e.g., the completed surveys 204) in response to the surveys 128 may be utilized by the prediction engine 138 to generate the predictive data 208. Furthermore, the prediction engine 138 may analyze user responses to each of the questions included in the surveys 128. More particularly, the prediction engine 138 may determine which questions and/or factors have a higher correlation to, or association with, the sales performance of games 202. For example, the prediction engine 138 may determine which factors and/or features associated with the games 202 are more predictive, or are the best predictors, of sales performance for that game 202, which questions included in the surveys 128 have a greater correlation to, or association with, higher games scores 206 for that game 202, and/or which questions included in the surveys 128 have a greater correlation to or association with, and are the best predictors of, a better sales performance of that game 202, which may include the amount of units sold of that game 202 and/or the sales revenue associated with that game 202. In various embodiments, a linear regression model and/or one or more predictive models 140 may be utilized to make such determinations.

In various embodiments, the prediction engine 138 may utilize any type of predictive model 140 and/or any type of regression analysis (e.g., a linear regression equation) in order to generate the predictive data 208. For the purposes of this discussion, a linear regression equation may refer to a series of additive and multiplicative weights (e.g., constants) applied to an independent variable(s) to create a predicted value of a dependent variable. In some embodiments, the additive and multiplicative constants may be derived from the historical sales data 134 and/or the pre-release game scores 206 from games 202 that have already been released. Moreover, the dependent variable may refer to user responses to questions included in the surveys 128 and the independent variable may refer to the predictive data 208, which may be representative of the predicted amount of units sold for a particular game 202 and/or the predicted sales revenue associated with that game 202. Furthermore, the linear regression equation may utilize each of the questions included in the surveys 128 or a subset (e.g., one or more) of those questions.

In other embodiments, the independent variable may correspond to a particular variable that is being manipulated, changed, or altered, such as the variable being manipulated, changed, or altered by the content server(s) 110. On the other hand, the dependent variable may correspond to a variable that is expected to change as a result of the changes to the independent variable. For instance, with respect to a particular game 202, the dependent variable(s) may correspond to a prediction of sales of the game 202, a number of units of the game 202 that are sold, a revenue associated with the game 202, and/or a pre-release game score 206 for the game 202. Moreover, the independent variable(s) may correspond to responses to the surveys 128 for the game 202 and/or predictive data 208 that may influence the dependent variable(s). In some embodiments, such predictive data 208 may be the prediction of the sales, units, revenue, and/or pre-release game score 206 associated with the game 202, as set forth above.

As stated above, the dependent and/or predictive variables included in the regression analysis equation and/or the predictive models 140 may be based on user responses to questions included in the surveys 128. In some embodiments, for each question included in the surveys 128, the responses submitted by the users 102 may be averaged. As a result, the user feedback associated with each question included in the surveys 128 may be averaged such that each question is associated with a single averaged response, which may be represented by a rating or a numerical value. By viewing the averaged response for a particular one of the questions (e.g., overall rating of game 202, pace of play, user enjoyability, etc.), the overall opinion of the users 102 that played the game 202 with respect to that question may be determined.

Alternatively, or in addition to averaging the user responses, the dependent and/or predictive variables included in the linear regression equation may represent a number and/or percentage of users 102 that rated the game 202 and/or one or more of the questions included in the surveys 128, above a predetermined threshold. For example, for a particular question included in the surveys 128, the variable may represent a percentage of users 102 that responded to the question favorably, such as by responding to the question with a certain score or rating. That way, the dependent and/or predictive variables may represent whether a certain percentage of the users 102 that tested the game 202 responded favorably to one or more questions included in the surveys 128 and/or various features associated with the game 202.

Furthermore, as stated above, the predictive data 208 generated by the prediction engine 138 may be representative of the predicted sales performance for a particular game 202. For instance, the predictive data 208 may be a prediction of the number of units of a particular game 202 that are expected to be sold. The predictive data 208 may also be indicative of the actual revenue that is received as a result of the sales of a particular game 202. In some embodiments, the sales revenue may be computed by multiplying the number of units sold of a particular game 202 by the price at which the game 202 was sold.

In example embodiments, for a particular one of the games 202, the linear regression equation and/or a particular predictive model 140 may be shown below in Equation 1:

B=a+Q₁(x)+Q₂%(y)+ . . . +Qₙ(z) (1)

Where B may represent the dependent variable (e.g., predictive data 208), Q may represent any one of the questions included in the surveys 128, a may represent an additive weight, and x, y, and z may represent varying constants or weights that are associated with the questions (e.g., Q₁, Q₂, Qₙ, etc.).

With respect to Equation 1, B may represent the predicted sales performance, such as the predicted amount of sales and/or the predicted revenue resulting from those sales, for a particular game 202. Moreover, Q₁ may refer to a first question included in the surveys 128, Q₂ may refer to a second question included in the surveys 128, and Qₙ may refer to an n^{th} question included in the surveys 128. In particular, the questions included within Equation 1 may be representative of the user's 102 response to those equations. Moreover, in some embodiments, Q₁, Q₂, and Qₙ may each correspond to any one of the questions included in the surveys 128 and any or all of the questions included in the surveys 128 may be included within Equation 1. As stated above, a may correspond to an additive weight. For instance, provided that Equation 1 were to be represented as a line on a graph, a may represent the y-intercept associated with the graph.

Additionally, x, y, and z may be constants and/or weights that may be based at least in part on historical data associated with games 202 that have already been released. For example, the questions (Q) may be weighted based on the relative degree in which responses to those questions are predictive of future sales performance. That is, if it is determined that responses to a first question (Q₁) are the best predictor of the amount of future sales, that first question may be weighted more heavily than other questions. In various embodiments, constants x, y, and z may be the same or different depending upon the extent to which the questions associated with those constants are predictive of future sales performance. Furthermore, positive and/or negative coefficients may be utilized in Equation 1.

In various embodiments, the % that is included in Equation 1 may represent any percentage of any data derived from the surveys 128. For instance, Q₂% may represent an average of the responses to any one, or multiple, of the questions included in the surveys 128. Moreover, Q₂% may also represent a particular percentage of responses for a specific question in the surveys 128, such as, for example, the number or percentage of people who indicated a particular response for a question (e.g., strongly like, dislike, etc.). In some embodiments, Q₂% may correspond to the percentage of users 102 that provided responses to a particular question included in the surveys 128 (e.g., Q₂) that exceeded a predetermined threshold. Although this percentage is shown in Equation 1 with respect to Q₂, this percentage may be associated with all, none, or a subset of the questions included in Equation 1. Moreover, the % may be associated with some questions included in the surveys 128, but not with others.

In certain embodiments, Equation 1 may also be written as Equation 2, as set forth below:

ŷ=a+b₁(x₁)+ . . . bi(xi) (2)

In some embodiments, ŷ may correspond to a prediction (e.g., sales, revenue, units sold, game score, etc.) associated with a particular game 202. Moreover, and as stated above, a may represent an additive weight that is determined based at least in part on historical data. b₁ through bᵢ may represent any question from the surveys 128 and Equation 2 may include any number of the questions. Moreover, x₁ may correspond to a multiplicative weight that is assigned based at least in part on historical data relating to a particular portion of data (b₁). In some embodiments, b₁ may be an average of responses to one or more of the questions of the surveys 128 or a percentage of survey takers that answered or rated a particular question in a certain way. For each piece of data that is added to Equation 2 (e.g., bᵢ), a particular weight (e.g., xᵢ) may be assigned to that data, where the weight may be based at least in part on the statistical relations that are determined from the historical data.

In addition, although not shown in Equation 1, the genres of the games 202 may be considered when determining future sales performance. For example, for a game 202 that is within a particular genre (e.g., hidden object, time management, etc.), historical data relating to other games 202 within that genre may be considered when predicting the amount of sales for that game 202. In addition, other data relating to a user's 102 experiences associated with one or more games 202 may be considered when generating the predictive data 208. For example, information such as the number of times the game 202 is played, a frequency of play, a duration of play, whether the game 202 has been acquired by a particular user multiple times (e.g., for different user devices 104), a location of the users 102 (e.g., geographic region, urban versus rural, etc.), a user's 102 prior interaction with the game 202 (e.g., whether the game 202 has been used, tried, played, viewed, downloaded, installed, etc.), demographic information about the users 102 (e.g., gender, age, etc.), user preferences (e.g., genres, etc.), and any other data may be utilized to predict future sales performance of a particular game 202 that is not yet publicly available.

Accordingly, based at least in part on user feedback relating to games 202, tracking the sales performance of those games 200, and generating correlations or associations therebetween, the system 202 may predict the amount of sales of a particular game 202 prior to that game 202 becoming available to consumers. More particularly, by authorizing certain users 102 to play a game 202 and provide feedback prior to that game being released, the creators and/or developers of the game 202 may modify the game 202 based on user preferences in order to develop an improved version of the game 202. Furthermore, predicting the future sales performance of a particular game 202 may also help determine how that game will be marketed and/or advertised to consumers.

### User Feedback for Games

FIG. 3 illustrates a diagram showing a process of soliciting feedback from consumers regarding one or more games and modifying the games based at least in part on user preferences. In various embodiments, a developer 106 may create and/or develop a game 202, which may be provided to one or more content server(s) 110. As stated above, the content server(s) 110 may be associated with an individual and/or entity that owns the rights to the game 202 and/or that is otherwise associated with the game 202. Prior to the game 202 becoming available to the public, it may be beneficial to receive user feedback associated with the game 202 so that the game 202 may be modified before the game 202 is released. That way, the best possible version of the game 202 may be presented to consumers and the game as a whole, and/or features of the game, may be consistent with user preferences.

In some embodiments, the content server(s) 110 may select a subset of users 102 (e.g., current customers, potential customers, etc.) to play the game 202 after the game 202 has been developed. For example, in exchange for being allowed to test and/or play the game 202 prior to that game 202 being available to other consumers, the user 102 may also have to provide feedback relating to the game 202. More particularly, the content server(s) 110 may provide a survey 128 or a questionnaire that may include one or more questions relating to the user's 102 experiences with the game. Example topics may include the overall quality of the game 202, whether the user 102 thought the game 202 was fun, and whether the user 102 would be likely to acquire (e.g., purchase, rent, etc.) the game 202. After playing the game 202 for a predetermined amount of time (e.g., an hour), the users 102 may return a completed survey 204 to the content server(s) 110. In addition to the completed surveys 204, the content server(s) 110 may also receive sales data 134. In various embodiments, the sales data 134 may refer to the sales of one or more games 202 since those games 202 have been released to consumers.

Based at least in part on the feedback provided by the users 102, the content server(s) 110 may generate a game score 206 for the game 202. The game score 206 may represent an overall impression of the game 202 by the users 102. For instance, a higher game score 206 may indicate that the users enjoyed the game 202 and/or were satisfied with the game 202, whereas a lower game score 206 may indicate that the users 102 believed that the game 202 did not meet expectations and/or that there were one or more features of the game 202 that could use modification and/or improvement. In other embodiments, the game score 206 may represent a prediction of the future sales performance (e.g., number of units sold, revenue, etc.) associated with that game 202. This prediction may be based at least in part on correlations or associations that have been established for games 202 that have already been released to consumers. For example, the content server(s) 110 may make correlations or associations between the game scores 206 that were generated for games 202 and the games' 202 subsequent sales performance.

In either embodiment, the developer 106, the content server(s) 110, and/or any other entity associated with the game 202 may utilize the game score 206 to help determine whether the game 202 should be released to consumers. The content server(s) 110 may release games 202 to consumers if the game scores 206 associated with those games 202 meets or exceeds a predetermined threshold. Since a high game score 206 may reveal that the users 102 were satisfied with and/or enjoyed the game 202, the game 202 may be released 302 to consumers. As stated above with respect to FIG. 2, the game score 206 that directly precedes release 302 of the game 202 may be referred to as the pre-release game score 206. In some embodiments, a pre-release game score 206 may be generated for a particular game 202 just to determine a level of user enjoyment associated with the game 202, even though that game 202 will be released 302 without further modification and/or development. Further, an additional game score 206 may be generated for a particular game 202 if there has been a significant amount of time since the previous game score 206 was generated.

In other embodiments, if the game score 206 does not satisfy the predetermined threshold, and/or if the user feedback indicates that there are features of the game 202 that need improvement, the game 202 may be modified 304 in any manner. For example, the graphics, sound, theme, pace of play, etc., may be modified based at least in part on the user feedback. Moreover, after the game 202 has been modified 304 and/or redeveloped, the survey 128 process may be repeated one or more times. In particular, the modified game 202 may again be provided to the users 102 with a corresponding survey 128. Upon the users 102 playing the game for a second time, the users 102 may submit their completed surveys 204 to the content server(s) 110. A second game score 306 may then be generated to determine whether the users 102 believe that the game has actually been improved. If so, and if the second game score 306 is greater than the first game score 206, and/or if the second game score 306 satisfies the predetermined threshold, the game 206 may be released 308. Otherwise, the game 202 may go through one or more additional iterations of the survey process until the game 202 meets the expectations of the developer 106, the one or more entities associated with the game 202, and/or the users 102.

In further embodiments, upon generating the game score 206, it may be determined that the game 202 should be abandoned 310 or otherwise redeveloped. For example, if the feedback indicated that the users 102 did not like the game 202, the game 202 may be discarded or may be redeveloped so that the game 202 is significantly different from its current form. Therefore, soliciting feedback from a group of users 102 may be helpful in determining whether games 202 should be modified prior to being released to consumers. Moreover, the game scores 206 and subsequent sales performance of various games 202 may be utilized to predict future sales performance (e.g., quantity of items sold, revenue, etc.) for games 202 that have not yet been made available to the public.

### Example Processes

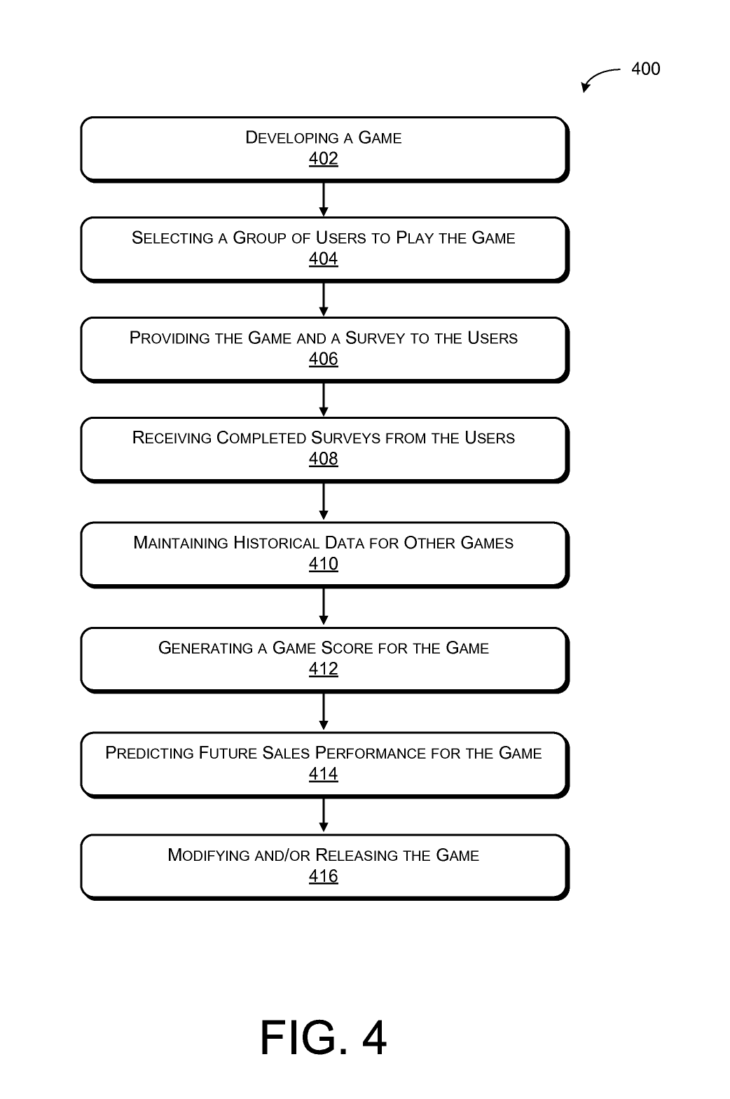

FIG. 4 describes various example processes of predicting the sales performance of one or more games. The example processes are described in the context of the environment of FIGS. 1-3 but are not limited to those environments. The order in which the operations are described in each example method is not intended to be construed as a limitation, and any number of the described blocks can be combined in any order and/or in parallel to implement each method. Moreover, the blocks in FIG. 4 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 4 is a flow diagram illustrating an example process of predicting the sales performance of a game. Moreover, the following actions described with respect to FIG. 4 may be performed by a server, an individual and/or entity that is somehow associated with the games 202, a merchant, and/or the content server(s) 110, as shown in FIGS. 1-3.

Block 402 illustrates developing a game. More particularly, a game developer and/or an entity may create one or more games that are to be played by consumers. The games may include casual games and may be included within one of many different genres of games (e.g., hidden object, time management, etc.). The games may be played by users via a user device, regardless of whether the games are downloaded to the user device, played via an application stored on the user device, streamed to the user device from a server, and/or played via a site (e.g., website, portal, etc.) associated with an individual and/or entity associated with the games.

Block 404 illustrates selecting a group of users to play the game. In some embodiments, after the game has been developed but prior to the game being publicly available to consumers, the creator and/or developer of the game may want to test the game. For example, the creator and/or developer of the game may desire to receive user feedback associated with the game to determine whether the game is likely to be of interest to consumers. Accordingly, a group of users may be selected to play the game for a limited period of time. The users that are selected to play a beta version of the game may be existing customers, potential customers, etc. Any manner may be utilized to select which users are authorized to play the game prior to release of the game.

Block 406 illustrates providing the game and a survey to the users. Furthermore, once the group of users has been selected, the beta version of the game and a survey associated with the game may be transmitted to the users. In various embodiments, a link to the game and the survey may be sent to the users (e.g., via e-mail, text message, instant message, etc.), the game and the survey may be accessible directly from a site (e.g., a website), etc. The survey may include one or more questions relating to the game and the survey may request user feedback in any form, such as numerical ratings, multiple choice, textual responses, etc. Example questions that may be included in the survey may relate to an overall quality of the game, the enjoyability of the game, a likelihood that the user will acquire (e.g., purchase, rent, etc.) the game, graphics and/or audio of the game, and/or a pace of the game. However, any aspect and/or feature of the game may be included in the survey.

Block 408 illustrates receiving completed surveys from the users. In some embodiments, the users may be given a predetermined amount of time to play the game (e.g., an hour). When the predetermined amount of time has expired, the users may be prompted to complete the survey associated with the game. The users may then complete the survey based on their respective experience with the game and then may return the completed survey.

Block 410 illustrates maintaining historical data for other games. In various embodiments, for games that have previously been released to consumers, the sales performance, such as the amount of units sold and/or the revenue associated with those games, may be monitored, collected, and maintained. Additionally, a game score may be generated for each of the games based at least in part on user feedback associated with the games that were provided to consumers prior to release. For each of the games, the content server may then determine any correlations or associations between the game score and the sales performance. For example, it may be determined that a higher overall game score for a game may be a reliable predictor that the game will experience a higher amount of sales, and vice versa. Moreover, the content server may also determine whether responses to certain questions included in the survey are better predictors of sales performance.

Block 412 illustrates generating a game score for the game. More particularly, based at least in part on the user feedback included in the completed surveys and/or the historical data described above, a game score may be generated for the game. In some embodiments, the game score may be derived in any manner and may be reflective of whether the users liked or disliked the game.

Block 414 illustrates predicting future sales performance for the game. In various embodiments, based at least in part on the game score determined for the game, the historical data maintained for previously released games, and/or correlations or associations that were determined for those games, the amount of sales and/or revenue associated with the game may be predicted. For example, based on the sales performance of games that had similar game scores prior to release, the systems and/or processes described herein may predict the sales performance of this game. As mentioned previously, the game score that preceded release of the games may be utilized to make such a prediction. Moreover, one or more predictive models and/or regression analysis may be utilized to predict future sales performance.

Block 416 illustrates modifying and/or releasing the game. Based at least in part on the game score generated for the game and/or the predicted sales performance, the content server may determine whether the game should be released, modified, or abandoned. More particularly, if the game score meets a predetermined threshold and/or meets certain expectations, the game may be released to consumers without any, or with little, modification. Alternatively, if the game score falls below the threshold, the game may be modified based on the user feedback. Subsequently, the game may be put through the survey process one or more times until the game is in a condition to be released to the public. For instance, once the game is modified, the game may be resent to the same or a different group of users, a second set of surveys may be sent to those users, completed surveys may be received, and a second game score may then be generated. If the second game score is sufficiently high, that version of the game may be released. In other embodiments, if the game score is relatively low, it may be determined that the game should be abandoned or redeveloped altogether.

Accordingly, the systems and/or processes described herein may develop games and then solicit feedback from consumers regarding one or more of those games. A group of users may be selected to play the games prior to those games being publicly available and the group of users may answer questions relating to those games that are included in a survey. A game score may then be generated for each of the games. Based on the game scores, it may be determined whether the game should be released as is or whether the game should be modified and then put through another iteration of the survey process. Moreover, based on the game scores and historical data relating to game scores and the sales performance of previously released games, the future sales performance (e.g., amount of sales, sales revenue, etc.) of those games may be predicted.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
selecting a group of users to play a game for a predetermined amount of time prior to the game being publicly available;
receiving feedback from one or more users included in the group of users after the predetermined amount of time has expired;
generating a game score for the game based at least in part on the feedback; and
predicting a future sales performance of the game based at least in part on the game score and historical data associated with one or more additional games.

2. The method as recited in claim 1, further comprising:
generating a game score for each of the one or more additional games;
tracking a sales performance of each of the one or more additional games; and
determining correlations or associations between the game scores and the sales performance.

3. The method as recited in claim 1, wherein the future sales performance includes a number of units of the game that are predicted to be sold or a predicted sales revenue associated with the game.

4. The method as recited in claim 1, further comprising:
providing the game and a survey that corresponds to the game to each user included in the group of users; and
receiving one or more completed surveys after the predetermined amount of time has expired.

5. The method as recited in claim 4, wherein the survey includes one or more questions relating to each user's experience with the game.

6. The method as recited in claim 1, wherein the future sales performance is predicted based at least in part on one or more predictive models or regression analysis.

7. The method as recited in claim 1, wherein the game is publicly available when the game can be acquired by consumers.

8. The method as recited in claim 1, further comprising releasing the game to consumers when it is determined that the game score exceeds a predetermined threshold.

9. The method as recited in claim 1, further comprising:
modifying the game when it is determined that the game score does not exceed a predetermined threshold;
receiving additional feedback from the group of users relating to the modified game;
generating a second game score for the modified game; and
releasing the game to consumers when it is determined that the second game score exceeds the predetermined threshold.

10. One or more computer-readable storage media including computer-executable instructions that, when executed by one or more processors, causes the one or more processors to perform operations comprising:
receiving feedback relating to one or more games prior to the one or more games becoming available to consumers;
generating game scores for the one or more games based at least in part on the feedback;
tracking sales performance of the one or more games after the one or more games become available to the consumers; and
for each of the one or more games, determining one or more correlations or associations between the game scores and the sales performance.

11. The computer-readable storage media as recited in claim 10, wherein the operations further comprise:
generating a game score for a game that is not yet publicly available based at least in part on user feedback associated with the game; and
predicting a future amount of sales for the game based at least in part on the game score and the one or more correlations or associations.

12. The computer-readable storage media as recited in claim 11, wherein the operations further comprise predicting a future sales revenue for the game based at least in part on the game score and the one or more correlations or associations.

13. The computer-readable storage media as recited in claim 11, wherein the future amount of sales is predicted utilizing a linear regression equation.

14. The computer-readable storage media as recited in claim 10, wherein the one or more correlations or associations indicate whether the game scores are a predictor of the sales performance of the one or more games.

15. A method, comprising:
providing a game and a survey associated with the game to a group of users who are authorized to play the game for a limited amount of time, the survey including one or more questions relating to the game;
generating a game score for the game that is derived from user responses to the one or more questions included in the survey; and
predicting a future amount of sales of the game based at least in part on the game score and historical data associated with one or more additional games.

16. The method as recited in claim 15, further comprising:
tracking and maintaining a sales performance associated with the game; and
determining which of the one or more questions are the most accurate predictors of the sales performance.

17. The method as recited in claim 15, wherein the historical data includes game scores generated for the one or more additional games, a sales performance associated with the one or more additional games, or one or more correlations or associations between the game scores and the sales performance of the one or more additional games.

18. The method as recited in claim 15, wherein the game score is generated by determining an average of the user responses to each of the one or more responses or determining a percentage of users included in the group of users that rated the question above a predetermined threshold.

19. The method as recited in claim 15, further comprising utilizing the game score to determine whether the game is to be released to consumers without modification or whether the game is to be modified prior to being released to consumers.

20. The method as recited in claim 19, further comprising:
modifying the game based at least in part on the user responses;
providing the modified game to the group of users and soliciting feedback from the group of users;
generating a second game score based at least in part on the feedback; and
based at least in part on the second game score, determining whether the modified game is to be released or whether the modified game is to be further modified.
